(19) United States
(12) Patent Application Publication
(10) Pub. No.: US 2012/0008156 A1
(43) Pub. Date: Jan. 12, 2012

(54) IMAGE-PROCESSING APPARATUS WITH OBLIQUE PLANE FOR SUPPORTING ORIGINALS

(76) Inventor: Chao-Yu Peng, Hsinchu City (TW)

(21) Appl. No.: 12/959,352

(22) Filed: Dec. 2, 2010

(30) Foreign Application Priority Data
Jul. 7, 2010 (TW) 099212967

(51) Int. Cl. H04N 1/04; G06F 3/12

(52) U.S. Cl. 358/1.13; 358/474; 358/498

(57) ABSTRACT

An image-processing apparatus is disclosed and includes a platform casing, a movable image-capturing device, and an operation panel. The platform casing includes a scan plane and an oblique plane for supporting an original. The oblique plane is disposed at a first side of the scan plane. The movable image-capturing device is movably installed in the platform casing for capturing an image of the original placed on the scan plane. The operation panel is connected to the platform casing and disposed at a second side of the scan plane. Thereby, a user may effortlessly operate the image-processing apparatus to scan a bound document.

### CROSS REFERENCE TO RELATED APPLICATIONS

This application claims the benefit of the foreign application priority of Taiwan Application No. 099212967, which was filed on Jul. 7, 2010 and is incorporated herein by reference.

### BACKGROUND OF THE INVENTION

1. Field of the Invention

The present invention relates to an image-processing apparatus, and especially relates to an image-processing apparatus with an oblique plane which is disposed at a side of the image-processing apparatus for supporting originals.

2. Description of the Prior Art

As the demand for document digitization grows day by day and the electronic technology continues to improve, a multi-function product (MFP) having multiple functions such as scanning, copying, and printing, in a signal product has been developed and becomes increasingly popular. Please refer to FIGS. 1 and 2. FIG. 1 is a schematic diagram of an MFP 3 according to the prior art. FIG. 2 is a schematic diagram of a scanning device of the MFP 3 in FIG. 1; therein, FIG. 2 shows only a cover 32, a platform 34, and an image-capturing device 36 of the MFP 3. In general, in the scan or copy operation on a book or a bound document, a part of a book 4 rests upon an operation panel 38 so that a page to be scanned can be placed flatly on the platform 34 to obtain a complete image of the page. Because the operation panel 38 is covered by the book 4, it is quite inconvenient for a user to input commands and settings for the operation, or to inspect the results of the complete scan. When using the prior art MFP 3, the user has to frequently lift the book 4 during the course of the operation and may carelessly move the book 4 when lifting the book 4. Such action may lead to negative impact on the quality of the scanned images, such as a slant scanned image, while, consequently, lengthening the time for scanning the book 4, since the user would have to redo the whole procedure.

### SUMMARY OF THE INVENTION

Accordingly, an object of the present invention is to provide an image-processing apparatus, which includes an oblique plane adjacent to an operation panel thereof for supporting originals, so a user can easily operate the image-processing apparatus to scan a bound document.

The image-processing apparatus of the present invention includes a platform casing, a movable image-capturing device, and an operation panel. The platform casing includes a scan plane and an oblique plane for supporting an original. The oblique plane is disposed at a first side of the scan plane. The movable image-capturing device is movably installed in the platform casing for capturing an image of the original placed on the scan plane. The operation panel is connected to the platform casing and disposed at a second side of the scan plane.

Because the oblique plane of the image-processing apparatus of the present invention is at the first side of the scan plane and slants away from a cover of the image-processing apparatus, the part of the spread book being scanned can be placed flatly on the scan plane while the part of the book not being scanned is placed naturally on the oblique plane. As an additional advantage, the configuration of the image-processing apparatus advantageously reduces or even eliminates the black shadows on the scanned images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an MFP according to the prior art.

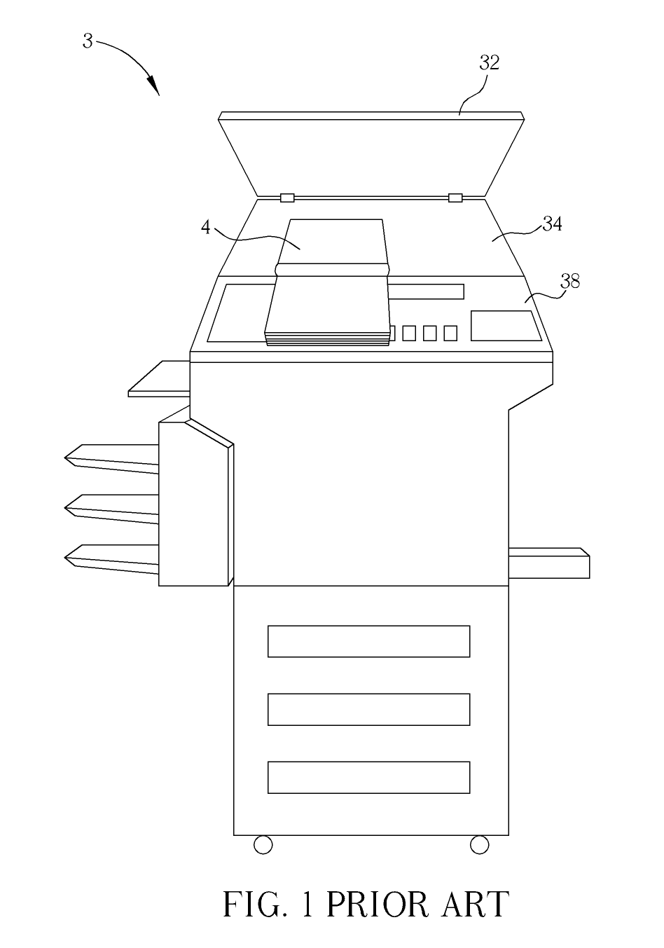

FIG. 2 is a schematic diagram of a scanning device of the MFP in FIG. 1.

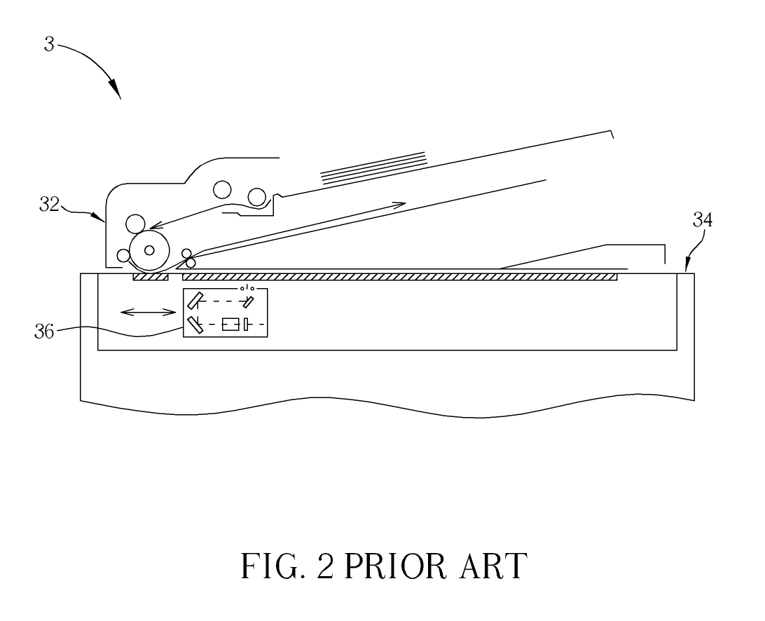

FIG. 3 is a schematic diagram of an image-processing apparatus according to a preferred embodiment of the present invention.

FIG. 4 is another schematic diagram of the image-processing apparatus in FIG. 3.

### DETAILED DESCRIPTION

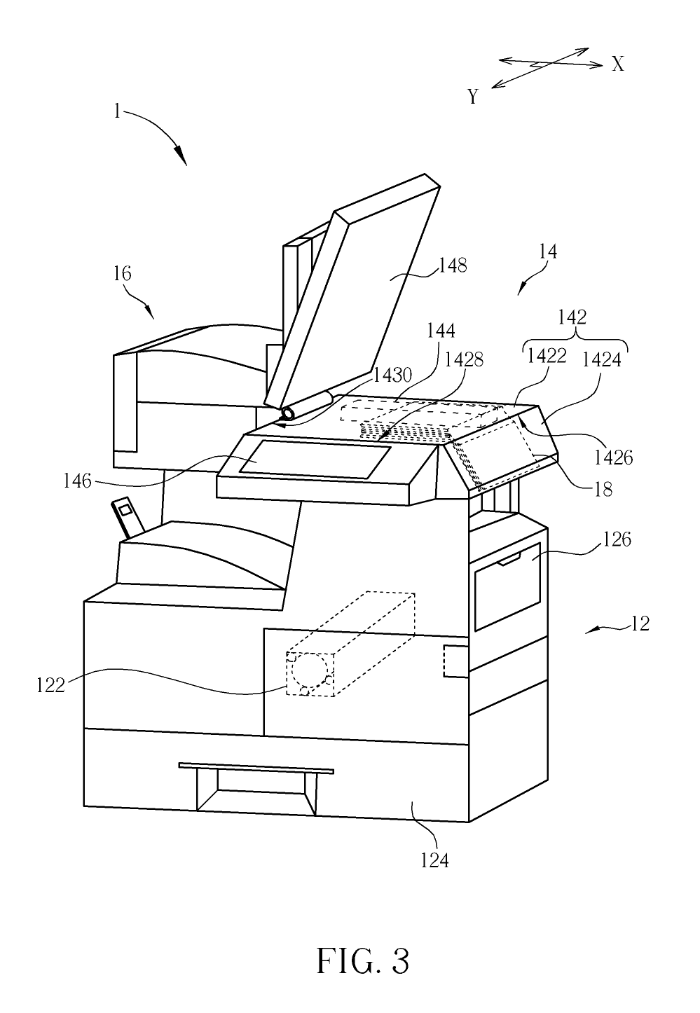

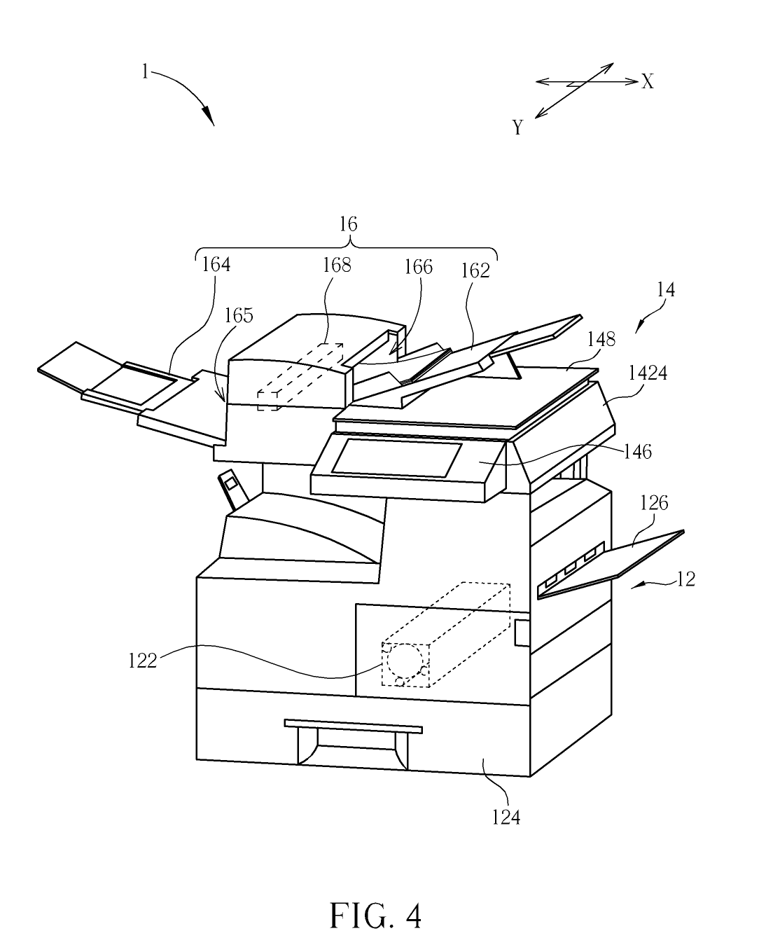

Please refer to FIG. 3 and FIG. 4. FIG. 3 is a schematic diagram of an image-processing apparatus 1 according to a preferred embodiment of the present invention. FIG. 4 is another schematic diagram of the image-processing apparatus 1 in FIG. 3. In the embodiment, the image-processing apparatus 1 is a MFP, but the present invention is not limited to this and the image-processing apparatus 1 can be any image-processing apparatus having scanning functions. The image-processing apparatus 1 includes a printer 12, a flatbed scanner 14, and a sheet-feeding scanner 16. Therefore, in the embodiment, the image-processing apparatus 1 has the functions of at least scanning, printing, and copying. The flatbed scanner 14 and the sheet-feeding scanner 16 are disposed above the printer 12, and three of them are integrated into one machine.

In the embodiment, the printer 12 is disposed under the flatbed scanner 14 and the sheet-feeding scanner 16 and includes an A3-size printer engine 122 (shown by dashed lines in FIG. 3 and FIG. 4), an A4-size paper cassette 124, and an A3-size multi-purpose feed-in tray 126. According to ISO 216 standard, A4 size is 210 mm×297 mm, and A3 size is 297 mm×420 mm. Therefore, the A3-size printer engine 122 means a printer engine capable of printing an image on an A3-size sheet of paper, and the A4-size paper cassette 124 means a paper cassette capable of accommodating A4-size sheets of paper while the A3-size multi-purpose feed-in tray 126 means a feed-in tray capable of accommodating A3-size sheets of paper. The flatbed scanner 14 includes a platform casing 142, a movable image-capturing device 144, an operation panel 146, and a cover 148. The platform casing 142 is disposed over the printer 12 and has a scan plane 1422 and an oblique plane 1424. The scan plane 1422 is used for supporting an original to be scanned by the movable image-capturing device 144, and the oblique plane 1424 is disposed at a first side 1426 of the scan plane 1422. In the embodiment, the original to be scanned is a book 18, but the present invention is not limited to it. In practice, the original can be loose sheets of paper, a card, a picture, and so on. The movable image-capturing device 144 (shown by dashed lines in FIG. 3) is movably installed in the platform casing 142, for capturing an image of the book 18 placed on the scan plane 1422. The movable image-capturing device 144 moves forth and back along a path in a direction Y in the platform casing 142 for capturing an image of a part or an entire page of the book 18. The operation panel 146 is connected to the platform casing 142 and disposed at a second side 1428 of the scan plane 1422. A user can input commands of scanning, copying, faxing, and so on, adjust setting, or use a value-added function of real-time preview on a display installed on the operation panel 146 of the image-processing apparatus 1. The oblique plane 1424 is disposed at the first side 1426 of the scan plane 1422 and slants away from the cover 148, i.e. slants downward. The user can spread the book 18 (schematically shown by dashed lines in FIG. 3) and place the book 18 face-down on the scan plane 1422 and the oblique plane 1424. Thereby, a page of the book 18 to be scanned can fittingly lay on the scan plane 1422, so as to eliminate the problem of the black shadows appearing on the duplicate image of the book page in the prior art. The first side 1426, where the oblique plane 1424 is located, is opposite a third side 1430 of the scan plane 1422. The design of the present invention allows the user to operate functions of the image-processing apparatus 1 of the present invention at the same time that a copy process of a book is carried out, but the present invention is not limited to this.

Furthermore, in the prior art, during the process of scanning or copying a book or a bound document, a part of the book often has to rest upon the operation panel so that a page to be scanned can be placed flatly on the platform. So the user has to lift the book to input commands or adjust settings, or inspect the result of the scanning. By lifting the book, the user may carelessly displace the book and cause to generate a skewed scanned image. On the contrary, in the image-processing apparatus 1 of the present invention, by utilizing a different configuration of the scan plane and the oblique plane to support the book, the operation panel is not covered any more, and the user can use the operation panel effortlessly and the impact on the quality of the scanned image due to displacement of the books is prevented.

In addition, in the embodiment, the cover 148 is pivotally connected to the platform casing 142 for covering the scan plane 1422. The cover 148 is disposed at the third side 1430 of the scan plane 1422. The third side 1430 is adjacent to the second side 1428. The cover 148 is designed to be capable of opening and closing sideward so that it is more efficient to press the page of the book 18 to be scanned flatly against the scan plane 1422.

In the embodiment, the sheet-feeding scanner 16 is disposed at the third side 1430 and includes a feed-in tray 162, a feed-out tray 164, a feed-in entry 166, a feed-out exit 165 (referring to FIG. 4), and a fixed image-capturing device 168. The feed-in tray 162 is mounted on the cover 148 and located at the feed-in entry 166 when the cover 148 is closed upon the scan plane 1422. A sheet of paper placed on the feed-in tray 162 can be fed through the feed-in entry 166 into the sheet-feeding scanner 16. The sheet of paper here is a loose sheet of paper. A maximum feed-in width of the feed-in entry 166 is substantially equal to 297 mm, so the sheet-feeding scanner 16 can scan a sheet of paper of A3 size at most.

Please refer to FIG. 3 together with FIG. 4. The movable image-capturing device 144 of the flatbed scanner 14 scans the original placed on the scan plane 1422 in a first direction X parallel to the second side 1428, while the fixed image-capturing device 168 of the sheet-feeding scanner 16 scans a sheet of paper entering the sheet-feeding scanner 16 from the feed-in tray 162 in a second direction Y parallel to the third side 1430. The second direction Y is substantially perpendicular to the first direction X. The directions for scanning mean the directions respectively in which image-sensing elements, e.g. photodiodes, of the image-capturing devices 144 and 168 are arranged. The image-processing apparatus 1 of the present invention uses at least one image-capturing device as the scan component for each of the flatbed scanner and the sheet-feeding scanner. On the contrary, an MFP or copier in the prior art uses a single common image-capturing device shared by the flatbed scanner and sheet-feeding scanner. With such the design, not only is the image-capturing device easily worn out, but deviations in the position of the image-capturing device also occur regularly.

In the embodiment, a length of the third side 1430 of the scan plane 1422 is substantially equal to 297 mm. A length of the second side 1428 of the scan plane 1422 is substantially equal to 210 mm. That is, the flatbed scanner 14 can support an original of A4 size at most. Of course, with the allowance in increasing the volume of the flatbed scanner 14, or within the footprint of the image-processing apparatus 1, the length of the second side 1428 of the scan plane 1422 can be designed to be substantially equal to 420 mm for accommodating an original of A3 size at most, so that the operation of scanning an A3-size document can be performed without using the sheet-feeding scanner 16. Especially for a document such as a bound book, the flatbed scanner 14 is to be used if the bound book is not allowed to be disassembled. It is noticeable that the present invention is not limited to the descriptions of the lengths of the scan plane 1422 and the scanning dimensions.

Based on the above explanation above and compared to the prior art, the flatbed scanner of the image-processing apparatus of the present invention is designed with a oblique plane, which makes a part of a book to be scanned be flatly placed on the scan plane naturally and easily, so as to rid black shadows off the scanned image and solve the problem of the book covering the operation panel. In addition, the cover of the image-processing apparatus of the present invention is designed to be capable of opening and closing sideward so that it is more efficiently to press the book against the scan plane. Besides, the image-processing apparatus of the present invention offers individual scanning devices for scanning documents in different scan directions, which improves the layout flexibility of the flatbed scanner and the sheet-feeding scanner and facilitates product upgrades. Therefore, a manufacturer can make a change to the design of the image-processing apparatus and replace one of the flatbed scanner and the sheet-feeding scanner without considering the compatibility requirement. The worn-out problem and the deviations in the position of the image-capturing device due to sharing the same image-capturing device can also be resolved.

Those skilled in the art will readily observe that numerous modifications and alterations of the device and method may be made while retaining the teachings of the present invention.

What is claimed is:

1. An image-processing apparatus, comprising:
a platform casing having a scan plane and an oblique plane for supporting an original, wherein the oblique plane is disposed at a first side of the scan plane;
a movable image-capturing device movably installed in the platform casing for capturing an image of the original placed on the scan plane; and
an operation panel connected to the platform casing and disposed at a second side of the scan plane.

2. The image-processing apparatus of claim 1, wherein the first side is adjacent to the second side.

3. The image-processing apparatus of claim 1, further comprising:
a cover pivotally connected to the platform casing and disposed at a third side of the scan plane for covering the scan plane, wherein the third side is adjacent to the second side.

4. The image-processing apparatus of claim 3, further comprising:
a sheet-feeding scanner disposed at the third side of the scan plane; and
a feed-in tray disposed on the cover.

5. The image-processing apparatus of claim 4, wherein the movable image-capturing device scans the original in a first direction parallel to the second side, the sheet-feeding scanner comprises a fixed image-capturing device for scanning a sheet of paper entering the sheet-feeding scanner from the feed-in tray in a second direction parallel to the third side, and the second direction is substantially perpendicular to the first direction.

6. The image-processing apparatus of claim 4, wherein the sheet-feeding scanner comprises a feed-in entry for a sheet of paper placed on the feed-in tray to enter the sheet-feeding scanner through the feed-in entry, and a maximum feed-in width of the feed-in entry is substantially equal to 297 mm.

7. The image-processing apparatus of claim 4, wherein a length of the third side of the scan plane is substantially equal to 297 mm.

8. The image-processing apparatus of claim 7, wherein a length of the second side of the scan plane is substantially equal to 210 mm.

9. The image-processing apparatus of claim 7, wherein a length of the second side of the scan plane is substantially equal to 420 mm.

10. The image-processing apparatus of claim 4, further comprising a printer disposed under the platform casing and the sheet-feeding scanner, wherein the printer comprises an A3-size printer engine, an A4-size paper cassette, and an A3-size multi-purpose feed-in tray.
